(19) United States
(12) Patent Application Publication
(10) Pub. No.: US 2008/0240675 A1
(43) Pub. Date: Oct. 2, 2008

(54) Coordinating Audio/Video Items Stored On Devices

(76) Inventors: Adam Berger, Pittsburgh, PA (US); Gregory C. Schohn, Brooklyn, NY (US)

Correspondence Address: FISH & RICHARDSON PC, P.O. BOX 1022, MINNEAPOLIS, MN, 55440-1022, US

(21) Appl. No.: 11/692,006

(22) Filed: Mar. 27, 2007

(51) Int. Cl. H04N 9/79

(52) U.S. Cl. 386/66; 386/124; 386/E05.054

(57) ABSTRACT

Among other things, at a portable device associated with a user, running a synchronization process to request from a network server synchronization of stored AV items on the portable device with AV items stored on a digital AV recorder also associated with the user, receive one or more files from the network server that correspond to one or more AV items stored on the digital AV recorder, and store the files on the portable device subject to a replacement policy based on available storage capacity on the portable device. At later times determined by the user, one or more of the AV items are presented to the user of the portable device based on the stored files.

### BACKGROUND

This description relates to coordinating audio/video (AV) items stored on devices.

A set-top box (STB), for example, can include a digital video recorder (DVR), that stores on a large-capacity magnetic disk drive TV programs received on a TV cable or satellite receiver. The stored programs can then be played back later (time shifted) or sent to a different device to be played back (place shifted) for later viewing.

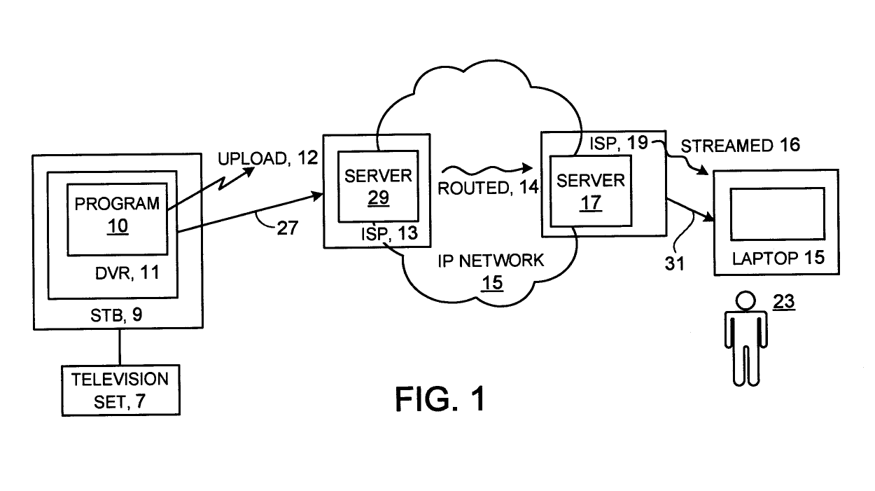

As shown in FIG. 1, place shifting can be done, for example, by uploading 12 a TV program 10 from the DVR 11 that is part of a STB 9 (associated with a television set 7) through a bandwidth-limited dial-up, DSL, or cable connection 27 to a server 29 of an Internet service provider (ISP) 13, then routed 14 through an Internet protocol (IP) network 15 to a server 17 of an ISP 19, and then real-time streamed 16 on a bandwidth-limited channel 31 to a personal computer, mobile phone, or other receiver 15 where a user 23 watches the program while it is streaming. An example includes Slingbox™ from Sling Media, Inc. of Foster City, Calif.

### SUMMARY

In general, in an aspect, at a server, information is received representing one or more AV (audio/video) items that have been received as an inbound network communication and stored on a digital AV recorder of a user, and based on the information, one or more files are delivered as an outbound network communication to a device of the user, for storage on the device and for later use in presenting one or more of the AV items to the user.

Implementations may include one or more of the following features. The information includes the AV items. The information identifies the AV items and does not include all of the AV items. The AV items that are not included in the information are obtained from a source other than the digital AV recorder, for example an accessible network storage. Each of the AV items corresponds to one or more of the files, and at least two of the files for one or more of the AV item are delivered at spaced apart times. The receipt of the information as an inbound network communication occurs at a time that depends on a network load. The delivering of the one or more files as an outbound communication occurs at a time that depends on a network load. The storage available on the device is insufficient to accommodate all of the files to be delivered, and a replacement policy is executed with respect to files stored on the device and files to be delivered. The AV items are received from the digital AV recorder through a proxy element. The files are delivered to the user device in cooperation with a synchronization process that is executed on the user device in a background mode. The files are delivered in response to a request from the synchronization process. The request is made at times determined by a schedule. The AV items are transcoded from a first format to a second format. The first format comprises a television-compatible format. The second format comprises a format compatible with the user device. The delivering of the files comprises non-real-time streaming delivery. The delivering of the files to the device of the user occurs without requiring intervention by or awareness of the user. Aspects of the delivering of the files are specified by the user. The timing of the delivering of the files is specified by the user. The replacement policy comprises a first-in first-out policy. The replacement policy comprises a last-in first-out policy. The replacement policy comprises replacing AV items most recently viewed by the user. The replacement policy comprises replacing AV items least frequently viewed by the user. The device comprises a portable device. The files for each of at least some of the AV items are delivered during a time period that differs from the time period required to present the AV item to a user on the device. Identification information is received enabling an association between the digital AV recorder and the device with respect to the AV items. The identification information is received in connection with the digital AV recorder registering itself with a proxy. The user controls which AV items are delivered to the device. The controlling comprises, with a web application, allowing a user to view AV items stored on the digital AV recorder and to select AV items to be received at the device. Selecting AV items comprises dragging and dropping AV items from the digital AV recorder to the user device. The AV items comprise advertisements.

In general, in an aspect, at a user device, in an inbound network communication, files are received from a server, the files representing AV items that are stored on a digital AV recorder associated with the user, and stored information on the device is updated based on the files, to enable later presentation of one or more of the AV items to a user of the device.

In general, in an aspect, at a digital AV recorder associated with a user, a request is received from a server based on a relationship between the digital AV recorder and a device associated with the user, and information is sent that is associated with AV items stored on the digital AV recorder to enable coordination by the server of AV items stored on the device with AV items stored on the digital video recorder.

In general, in an aspect, at a portable device associated with a user, running a synchronization process to request from a network server synchronization of stored AV items on the portable device with AV items stored on a digital AV recorder also associated with the user, receive files from the network server that correspond to AV items stored on the digital AV recorder, and store the files on the portable device subject to a replacement policy based on available storage capacity on the portable device. At later times determined by the user one or more of the AV items are presented to the user of the portable device based on the stored files. The synchronization process can log presentations of advertisements for reporting to the server.

These and other aspects and features alone and in combinations may be expressed as methods, systems, apparatus, program products, as means for performing functions, and in other ways.

Other aspects and features will be apparent from the following description and the claims.

### DESCRIPTION

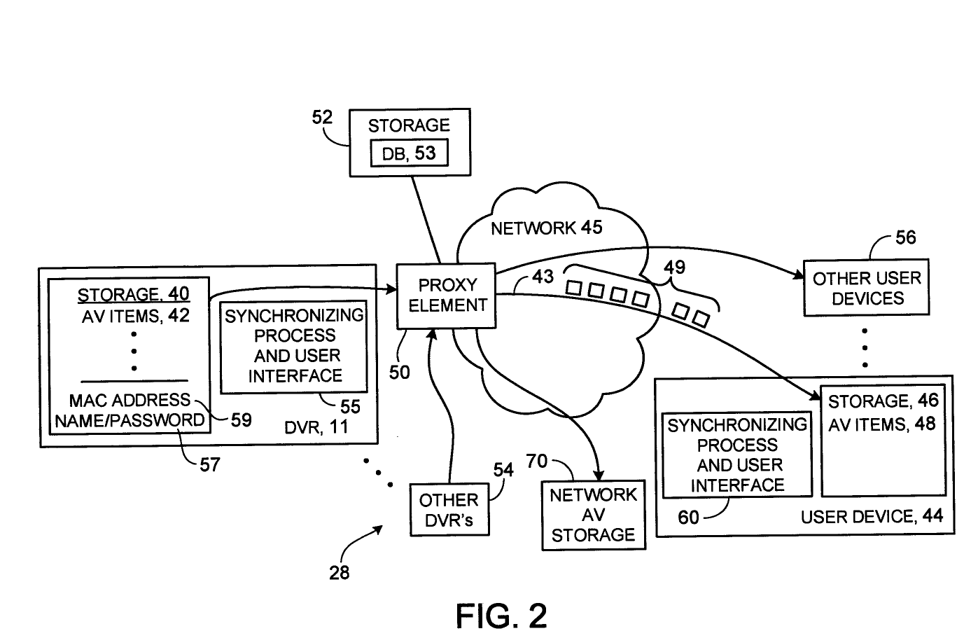

FIGS. 1 and 2 are block diagrams.

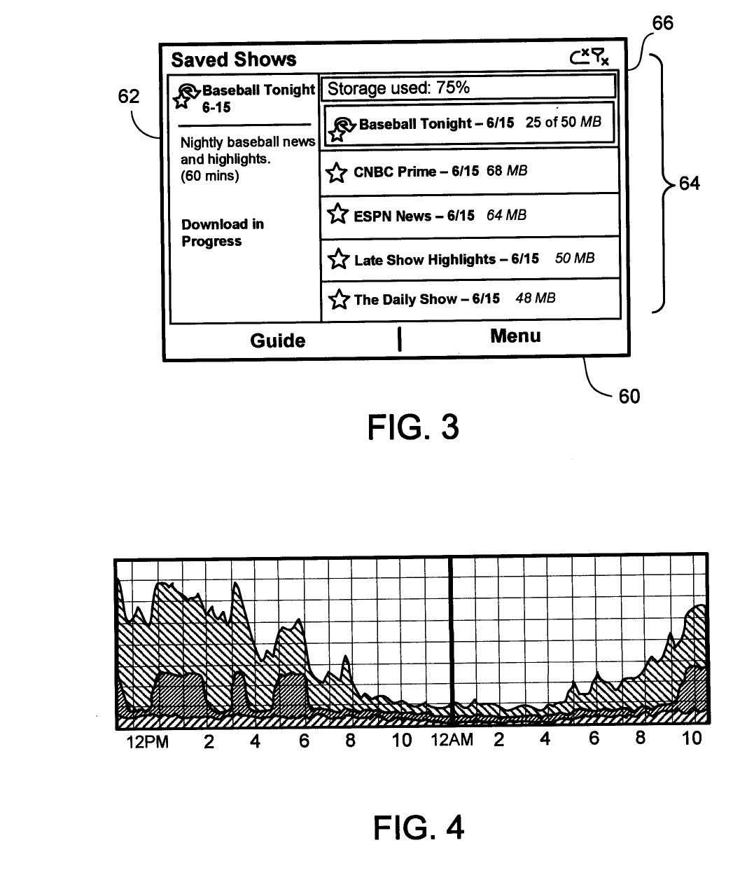

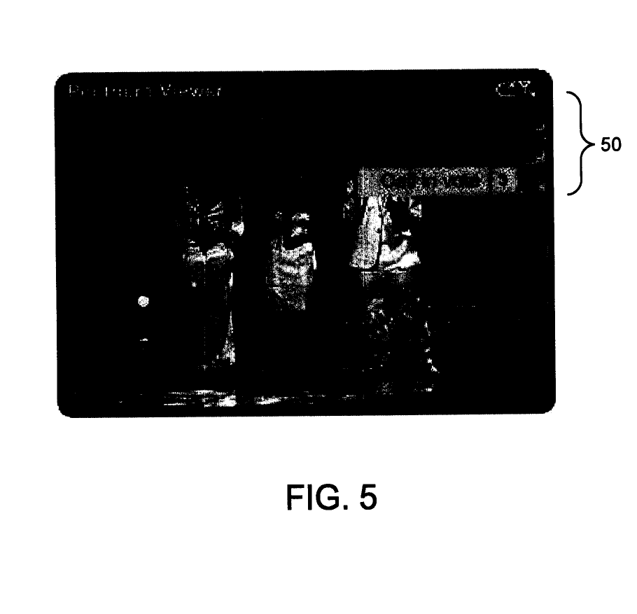

FIGS. 3 and 5 are screenshots.

FIG. 4 is a graph.

By synchronizing stored AV items on a user device (such as a mobile telephone) with stored AV items on the user's digital AV recorder (e.g., a DVR associated with a set top box, STB) in a manner that does not require streaming of the items at the time of presentation to the user, a higher quality of presentation of the AV items to the user on the device can often be achieved. The intensive use of network capacity associated with carrying large AV items can be shifted to times when that use will not interfere as much with uses of the network that are committed to higher priority services such as voice telephone calls. In addition, communication service providers can more easily create convergent offerings that include the presentation on the device of video programs stored on the user's digital AV recorder.

AV items include audio, video, or audio/video programs, segments, advertisements, and other pieces of AV material that can be presented to a user on a user device. Digital AV recorders include DVRs, and any other digital devices that can store video material, audio material, or audio/video material. A user device can be any device capable of presenting AV material to a user, including portable devices such as music players, mobile phones, personal digital assistants, laptop computers, and game players, and non-portable devices such as computers.

As shown in FIG. 2, in a system 28, one or more AV items 42 that have been stored for a user in a large capacity storage 40 of a digital AV recorder such as a DVR 11 are communicated 43 through a network 45 to and are stored in a storage 46 of a user device 44 (such as a mobile phone) for later presentation to the user and without causing network capacity concerns that could occur if the AV items were streamed to the user device, for example, at the time of presentation to the user. Relatively high quality uninterrupted presentation of the items to the user can be performed from the items stored on the user device at times convenient to the user. The user can have the items presented when and where he chooses. For example, items delivered in the middle of the night to a user's cell phone can be viewed the next morning on the subway. Thus, in addition to being able to time shift the playback, the user can also place shift the playback to the user device.

In some implementations, the AV items that are stored on the digital AV recorder are received from a communication network, for example, a television cable system or the Internet through a broadband telephone connection, or in other ways. The received AV items may be presented to the user of a television set associated with the digital AV recorder in real time when the AV items are being broadcast. In some implementations, the user can configure and control the digital AV recorder to record selected AV items for later presentation to the user. The identity of the AV items that are stored on the AV recorder can change frequently as new items are recorded and old items are deleted from the storage.

System 28 synchronizes the items that are stored in the user device with the items that are stored in the digital AV recorder so that the items that the user has chosen to be held in the digital AV recorder are also available to him for presentation on the user device. By synchronization we mean that some of the same AV items are stored both on the recorder and the device. The synchronization need not, however, apply to every item that is stored on the recorder or the device. For example, the synchronization may lag in time depending on the connectivity of either or both of the recorder and the device to the corresponding communication network. Also, the user can control in complete detail which ones (or which types or which groups) and how many of the AV items that are on the recorder will also be stored on the device. In many cases, the storage capacity of the recorder will be greater than the storage capacity of the device. This limitation will sometimes constrain the ability of the recorder and device to remain completely synchronized.

The network 45 can be any network (or combination of networks) using any protocol (or combination of protocols) for network communication. The networks can include unidirectional broadcast networks such as ATSC (advanced televisions systems committee), DVB-H (digital video broadcasting handhelds), and S-DMB (satellite digital multimedia broadcasting) and two-way networks such as TCP/IP (transmission control protocol/internet protocol), DSL, Ethernet, UMTS/HSDPA (universal mobile telephony system/high speed downlink packet access), EVDO (evolution data optimized), or GPRS (general packet radio service). The protocols can include hypertext transfer protocol (HTTP), or simple network management protocol (SNMP). These are only examples.

In some implementations, the communication of the AV items occurs through a server 50 that takes the form of a proxy element that is under control of a network service provider's private network. The proxy can serve a large number of DVR's 54. The server 50 uses a storage 52 to hold a database 53 that includes information associated the user device 44 and potentially a large number of other user devices 56, information associated with the digital AV recorder, information concerning the transmitting of AV items between the recorders and the devices, and information about the bandwidth available in the network to carry the AV items in the form of a load table. Although only a single network 45 is shown in FIG. 2, the network can actually comprise a combination of private and public networks including IP networks, cable networks, broadcast networks, or dial-up networks.

The digital AV recorders can be any network communication-capable devices having persistent storage media, for example, DVR set-top boxes. The user devices can be any network communication-capable devices having persistent storage media.

Each of the digital AV recorders 11, 54, typically includes a user interface 55 through which the user can configure the digital AV recorder to store certain incoming AV items at specified times and then to perform them later at the request of the user. In the system of FIG. 2, the user interface can be supplemented to enable the user to specify AV items that he wants to have synchronized on the user's device, when he wants to have them synchronized and other information useful in implementing the synchronization. (Although we refer to synchronizing AV items from the recorder to the user's device, and the notion that synchronization can occur between a recorder and a user device for many different users, the system also enables a given user to synchronize between more than one of his recorders and a user device or between a single recorder and more than one user device or between multiple recorders and multiple user devices associated with the user.)

For example, the user can select specific television programs stored, or to be stored, on a DVR set-top box for download to the user's mobile phone. In addition, to assist in configuring the recorder for transmitting AV items to the user device, a unique user name and password 57 can be associated with the recorder. Along with a unique hardware identifier for the recorder, e.g., a MAC address 59, the username and password 57 distinguish the recorder from other possible recorders being served on the network 45. This identification information can be uploaded to the network 45 and stored and maintained by the proxy element 50 in a data structure in the database 53.

The digital AV recorder also runs a synchronization process 55 that enables the recorder to respond to requests for information (e.g., from the proxy element) about which AV items are stored on the recorder, what changes have occurred since an earlier inquiry, the MAC address, the user identifier and password, and the identity or nature of the user devices with which synchronization is to occur. In some examples, the synchronization process also manages the actual delivery of the AV items to the proxy element for forwarding to the user devices.

Each of the user devices 44, 56 also runs a synchronizing process and user interface that, among other things, enables a user to configure the device to request of the proxy element 50 AV items that are to be synchronized, and enables the device to make the request and to receive the AV items. The process and UI 60 are configured (for example, by the user) to have the same username and password and the same MAC address information as stored in the recorder. When the user device communicates with the proxy element, the user device provides some or all of this unique identification information to enable the proxy element to associate the request with a known recorder on its network.

In some implementations, one screen of the user interface 60, as shown in FIG. 3, allows a user to view the download status 62 for each of the AV items 64 that has been received or is to be received, on the user device and the percentage of storage of the device that is being used.

In some implementations, the source from which the AV items are delivered to the user devices need not be the recorder itself but can be (as shown in FIG. 2) be an accessible network AV storage 70. The network AV storage can be operated by privately by the operator that controls the proxy element or could be operated by one or more other parties. The network AV storage could be arranged to store copies of all AV items that are broadcast to digital AV recorders over a period of time, e.g. a previous week or longer. The proxy server can access the desired AV item from the network AV storage rather than incurring significant data traffic over the low-bandwidth connection to, e.g., a home DVR. In such an arrangement, information is passed from the digital recorder to the proxy element to identify which AV items are stored on the recorder and which ones the user intends to be synchronized to the user devices, but the actual AV items are not sent from the digital recorder to the proxy element.

The synchronizing process 55 can be configured to connect to the proxy element according to a pre-set schedule to automatically receive the AV items that are intended for it. For example, in order to avoid interrupting voice function with a mobile phone, the user can configure the synchronizing process to connect to the server at midnight everyday, e.g., a time when the user believes it is less likely that he or she will make any telephone calls. The request can be made in a background mode so that the user is not required to take any action and need not even be aware that the synchronization is occurring.

The synchronizing process can also be configured to seek downloads of the AV items only in accordance with available bandwidth capacity of the network. For example, as shown in the table of FIG. 4, network load typically varies widely during any given day. As an example, the network can have excess capacity late at night and through the early morning hours, e.g., between 10 pm and 4 am. During other hours, e.g., between noon and 6 pm, the network may be at its peak usage. Transmitting and receiving AV items during peak usage hours could challenge the capacity of the network and deny bandwidth to other users, e.g., voice service users of mobile phones. Given concerns over network bandwidth, the synchronization process can be configured to connect to the server according to the bandwidth, e.g., specifically during low usage hours when the network can handle the increased data traffic of transmitting and receiving the AV items.

In some examples, the AV items are transmitted by the digital recorder and received at the server in a first file format, and the server converts them into a second file format. The first file format is, e.g., one suitable for viewing on an NTSC or HD television 7. The second file format is a format suitable for viewing on the user device, e.g., a mobile phone with a QVGA screen.

None, some, or all of the features of the synchronization process may be performed continually or at recurring, scheduled times, without requiring user intervention or a user request. In some implementations, none, some, or all of the features may also be provided in a foreground mode in response to a user's request.

Given that real-time streaming media can cause quality issues due to bandwidth-limited network connections (e.g., frequent rebuffering and dropped connections resulting in poor viewing experience and dependence on network coverage), the system 28 can use asynchronous delivery of the AV items in a non-real-time streaming manner. In some implementations, each item can be represented by a file and the downloading of the file can be interrupted and restarted as needed to accommodate changes in network capacity, errors in transmission, and for other reasons. In some implementations that could be more cumbersome, a television program media file stored on a DVR set-top box can be split into a series of files 49 and each of the files sent at a different time, again in order to accommodate the network bandwidth and network-connection sensitive system. Splitting can occur at the digital recorder, or at the server. The transmission of a non-streamed file or files 49 allows for efficient detection of and recovery from lost packets, dropped signals, or a noisy network. When network conditions are favorable for the synchronization process to connect to the server, the single file associated with an item or one, some, or all the series of files that make up an AV item can be transmitted to and received by the receiver device over the network. As mentioned earlier, transmission of the single AV file or one or more of a set of files that represent an AV item can be suspended at times of high network loads, and resumed during low network loads. These examples can result in transmitting an AV item over multiple periods of a day. In this manner, the AV item may be delivered at slower or faster than real-time streaming, e.g., an hour-long video program may require more (or less) than an hour to fully transmit.

If a network connection is lost, e.g., in no coverage areas such as subways, tunnels, or elevators, data transmission is not affected because transmission of the one or more of the files can resume once connection is re-established. Once the AV item has been fully transmitted, and received, and stored, the user can have the AV item presented to him anytime, anywhere, without concern for audio and video quality issues associated with real-time streaming.

In cases in which the persistent storage medium on the recorder is larger than the persistent storage medium on the user device, the user can specify the AV items he wants to make available on the user device. In some implementations, the synchronization process can be configured using a storage-replacement policy, which can be executed when the persistent storage medium is exhausted. Examples of storage-replacement policies can include any storage-replacement policy including a first-in first out policy (FIFO) or a last-in first-out policy (LIFO). Other examples include policies to replace AV items most recently viewed, or to replace AV items least frequently viewed.

In some implementations, advertisements stored on the server or recorder can be transmitted to and received by the user device. The advertisements can be integrated into the presentation of the AV items. For example, the advertisements can be inserted before, during, or after an AV item plays, or on an idle screen. In these examples, the synchronization process logs all presentations of the advertisements and can report this information to the server. claim?

As shown in FIG. 5, some implementations allow for user interaction with a playing AV item. For example, while enjoying a television program, the user can press buttons 50 to interact with the program. The buttons 50 instruct the synchronization process to activate other functions of the user device, e.g., voice functions, web browser, or short message service (SMS).

The techniques described here can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment.

Method steps of the techniques described herein can be performed by one or more programmable processors executing a computer program to perform functions by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. Generally, a computer will include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Other implementations are within the scope of the following claims.

For example, the techniques could apply to and the phrase AV items is meant to include any television or radio items or any other video or audio material, for example, ring tones, as well as software applications, and any other programs, processes, information, or content that the user device application may need or be capable of using and which can be downloaded and processed in the background with respect to the operation of the client application. Background functions include functions that can be conducted at least partly without disturbing or requiring action by the user of the device and sometimes without the user being aware that they are occurring.

In some implementations, a web application (e.g., one that is accessible from a personal computer) can allow a user to view content that is stored on the recorder of a STB and select individual items to be copied to the user device. The interface could permit dragging and dropping files from the STB to the user device in a manner similar to the interfaces provided for FTP transactions.

1. A method comprising
at a server, receiving information representing one or more AV items that have been received as an inbound network communication and stored on a digital AV recorder of a user, and
based on the information, delivering one or more files as an outbound network communication to a device of the user, for storage on the device and for later use in presenting one or more of the AV items to the user.

2. The method of claim 1 in which the information includes the AV items.

3. The method of claim 1 in which the information identifies the AV items and does not include all of the AV items.

4. The method of claim 3 in which the AV items that are not included in the information are obtained from a source other than the digital AV recorder.

5. The method of claim 1 in which each of the AV items corresponds to one or more of the files, and at least two of the files for one or more of the AV items are delivered at spaced apart times.

6. The method of claim 1 in which the receipt of the information as an inbound network communication occurs at a time that depends on a network load.

7. The method of claim 1 in which the delivering of the files as an outbound communication occurs at a time that depends on a network load.

8. The method of claim 1 in which the storage available on the device is insufficient to accommodate all of the files to be delivered, and the method also includes executing a replacement policy with respect to files stored on the device and files to be delivered.

9. The method of claim 1 in which the receiving of the AV items includes receiving the AV items from the digital AV recorder through a proxy element.

10. The method of claim 1 in which the files are delivered to the user device in cooperation with a synchronization process that is executed on the user device in a background mode.

11. The method of claim 10 in which the files are delivered in response to a request from the synchronization process.

12. The method of claim 11 in which the request is made at times determined by a schedule.

13. The method of claim 1 also including transcoding the AV items from a first format to a second format.

14. The method of claim 13 in which the first format comprises a television-compatible format.

15. The method of claim 13 in which the second format comprises a format compatible with the user device.

16. The method of claim 1 in which the delivering of the files comprises non-real-time streaming delivery.

17. The method of claim 1 in which the delivering of the files to the device of the user occurs without requiring intervention by or awareness of the user.

18. The method of claim 1 in which aspects of the delivering of the files are specified by the user.

19. The method of claim 18 in which the timing of the delivering of the files is specified by the user.

20. The method of claim 8 in which the replacement policy comprises a first-in first-out policy.

21. The method of claim 1 in which the device comprises a portable device.

22. The method of claim 1 in which the files for each of at least some of the AV items are delivered during a time period that differs from the time period required to present the AV item to a user on the device.

23. The method of claim 1 also including receiving identification information enabling an association between the digital AV recorder and the device with respect to the AV items.

24. The method of claim 23 in which the identification information is received in connection with the digital AV recorder registering itself with a proxy.

25. The method of claim 1 in which the user controls which AV items are delivered to the device.

26. A medium bearing instructions to enable a server to
receive information representing one or more AV items that have been received as an inbound network communication and stored on a digital AV recorder of a user, and
based on the information, deliver files as an outbound network communication to a device of the user, for storage on the device and for later use in presenting one or more of the AV items to the user.

27. A server configured to
receive information representing one or more AV items that have been received as an inbound network communication and stored on a digital AV recorder of a user, and
based on the information, deliver files as an outbound network communication to a device of the user, for storage on the device and for later use in presenting one or more of the AV items to the user.

28. A method comprising
at a user device, receiving from a server, in an inbound network communication, files representing AV items that are stored on a digital AV recorder associated with the user, and updating stored information on the device based on the files, to enable later presentation of one or more of the AV items to a user of the device.

29. The method of claim 28 in which the files are derived from the AV items that are stored on the digital AV recorder.

30. The method of claim 28 in which the files are derived from copies of the AV items that are not stored on the digital AV recorder.

31. The method of claim 28 in which one or more of the files corresponding to one or more of the AV items are received at spaced apart times.

32. The method of claim 28 in which the receipt of the files occurs at a time that depends on a network load.

33. The method of claim 28 in which the storage available on the device is insufficient to accommodate all of the files to be delivered, and the method also includes executing a replacement policy with respect to files stored on the device and files to be delivered.

34. The method of claim 28 in which the files are received at the user device by execution of a synchronization process on the user device in a background mode.

35. The method of claim 34 in which the files are received in response to a request from the synchronization process.

36. The method of claim 35 in which the request is made at a time determined by a schedule.

37. The method of claim 28 in which the receipt of the files comprises non-real-time streaming delivery.

38. The method of claim 28 in which the receipt of the files to the device of the user occurs without requiring intervention by or awareness of the user.

39. The method of claim 28 in which aspects of the delivering of the files are specified by the user.

40. The method of claim 33 in which the replacement policy comprises a first-in first-out policy.

41. The method of claim 28 in which the device comprises a portable device.

42. The method of claim 28 in which the one or more files for each of at least some of the AV items are received during a time period that differs from the time period required to present the AV item to a user on the device.

43. The method of claim 42 also including the user device providing identification information enabling an association between the digital AV recorder and the device with respect to the AV items.

44. The method of claim 28 in which the user controls which AV items are received at the device.

45. A medium bearing instructions to enable a user device to
receive from a server, in an inbound network communication, files representing AV items that are stored on a digital AV recorder associated with the user, and updating stored information on the device based on the files, to enable later presentation of one or more of the AV items to a user of the device.

46. A user device configured to
receive from a server, in an inbound network communication, files representing AV items that are stored on a digital AV recorder associated with the user, and updating stored information on the device based on the files, to enable later presentation of one or more of the AV items to a user of the device.

47. A method comprising
at a digital AV recorder associated with a user, receiving from a server a request based on a relationship between the digital AV recorder and a device associated with the user, and sending information associated with AV items stored on the digital AV recorder to enable coordination by the server of AV items stored on the device with AV items stored on the digital video recorder.

48. The method of claim 47 in which the information includes the AV items.

49. The method of claim 47 in which the information identifies the AV items and does not include all of the AV items.

50. The method of claim 47 in which the sending of the information occurs at a time that depends on a network load.

51. The method of claim 47 in which the information is sent through a proxy element.

52. The method of claim 47 also including sending identification information from the digital AV recorder enabling an association between the digital AV recorder and the device with respect to the AV items.

53. The method of claim 47 in which the identification information is sent in connection with the digital AV recorder registering itself with a proxy.

54. A medium bearing instructions to enable a digital AV recorder associated with a user to
receive from a server a request based on a relationship between the digital AV recorder and a device associated with the user, and
send information associated with AV items stored on the digital AV recorder to enable coordination by the server of AV items stored on the device with AV items stored on the digital video recorder.

55. A digital AV recorder associated with a user and configured to
receive from a server a request based on a relationship between the digital AV recorder and a device associated with the user, and
send information associated with AV items stored on the digital AV recorder to enable coordination by the server of AV items stored on the device with AV items stored on the digital video recorder.

56. A method comprising
at a portable device associated with a user, running a synchronization process to
request from a network server synchronization of stored AV items on the portable device with AV items stored on a digital AV recorder also associated with the user,
receive files from the network server that correspond to AV items stored on the digital AV recorder, and
store the files on the portable device subject to a replacement policy based on available storage capacity on the portable device, and
at later times determined by the user, presenting one or more of the AV items to the user of the portable device based on the stored files.

57. The method of claim 8 in which the replacement policy comprises a last-in first-out policy.

58. The method of claim 8 in which the replacement policy comprises replacing AV items most recently viewed by the user.

59. The method of claim 8 in which the replacement policy comprises replacing AV items least frequently viewed by the user.

60. The method of claim 33 in which the replacement policy comprises a last-in first-out policy.

61. The method of claim 33 in which the replacement policy comprises replacing AV items most recently viewed by the user.

62. The method of claim 33 in which the replacement policy comprises replacing AV items least frequently viewed by the user.

63. The method of claim 1 in which the AV items comprise advertisements.

64. The method of claim 28 in which the AV items comprise advertisements.

65. The method of claim 10 in which the synchronization process logs presentations of advertisements for reporting to the server.

66. The method of claim 44 in which the controlling comprises, with a web application, allowing a user to view AV items stored on the digital AV recorder and to select AV items to be received at the device.

67. The method of claim 66 in which selecting AV items comprises dragging and dropping AV items from the digital AV recorder to the user device.
